(19) United States
(12) Patent Application Publication
(10) Pub. No.: US 2016/0283948 A1
(43) Pub. Date: Sep. 29, 2016

(54) END USER TREND IDENTIFICATION TO IDENTIFY INFORMATION GAPS

(71) Applicant: HEWLETT PACKARD ENTERPRISE DEVELOPMENT LP, Houston, TX (US)

(72) Inventors: Yariv Snapir, Yehud (IL); Gad Sakin, Yehud (IL); Leonid Reznik, Yehud (IL); David Baron, San Diego, CA (US); Michael Dikamn, Yehud (IL)

(21) Appl. No.: 15/033,084

(22) PCT Filed: Oct. 29, 2013
(86) PCT No.: PCT/US13/67208

§ 371 Date: Apr. 28, 2016

(51) Int. Cl. G06Q 30/00; G06Q 10/00; G06F 17/30

(52) U.S. Cl. CPC G06Q 30/016; G06F 17/30598; G06F 17/30528; G06Q 10/20; G06F 17/30864; G06F 17/3053

(57) ABSTRACT

End user trend identification to identify information gaps can include tracking end user interactions with an information system, determining a number of end user technical issues based on the end user interactions with the information system, analyzing trends of the number of end user technical issues over a period of time, and identifying a number of information gaps within the information system based on the trends of the number of end user technical issues.

### BACKGROUND

Information systems can include various information that can be utilized by end users information systems can lack information associated with particular areas. Information technology (IT) managers can be responsible for creating additional information for the information systems to eliminate the issue of the the lack of information.

### BRIEF DESCRIPTION OF THE DRAWINGS

FIG. 1 illustrates a diagram of an example of an environment for end user trend identification to identify information gaps according to the present disclosure.

FIG. 2 illustrates a diagram of an example of a visual representation of a user interface for end user trend identification to identify information gaps according to the present disclosure.

FIG. 3A illustrates a diagram of an example of a system for end user trend identification to identify information gaps according to the present disclosure.

FIG. 3B illustrates a diagram of an example computing device according to the present disclosure.

FIG. 4 illustrates a flow diagram of an example method for end user trend identification to identify information gaps according to the present disclosure.

### DETAILED DESCRIPTION

End user trend identification to identify information gaps can include identifying a number of information gaps within an information system based on trends of a number of end user technical issues. End users can include users of software and/or hardware products. For example, end users can include a human user that purchases a software and/or hardware product for us by the human user. End user trend identification to identify information gaps can include an information system (e.g., database that includes data, database that includes IT articles, etc.) that includes a plurality of information technology (IT) articles (e.g., data relating to computing devices, articles relating to end user computing devices, etc.) that can be utilized by the number of end users to solve the number of end user technical issues (e.g., computing device technical issues, etc.). For example, the information system can be an end user help database that the end user can utilize to solve technical issues.

End user trend identification to identify information gaps can be utilized to analyze trends of the number of end user technical issues over a period of time. Analyzing trends of the number of end user technical issues can be utilized to determine end user technical issues that occur more often as compared to other technical issues among a plurality of end users. End user technical issues that occur more often can he addressed by an information system manager prior to other end user technical issues that occur less often. The trends of the number of end user technical issues can be used to prioritize the creation of IT articles (e.g., text documents relating to IT topics and/or categories, descriptions of IT information, descriptions on how to solve technical issues, etc.) that correspond to particular end user technical issues. For example, end user technical issues that occur more often can be prioritized, and IT articles can be generated to address the end user technical issues that occur more often and are not already covered by existing IT articles.

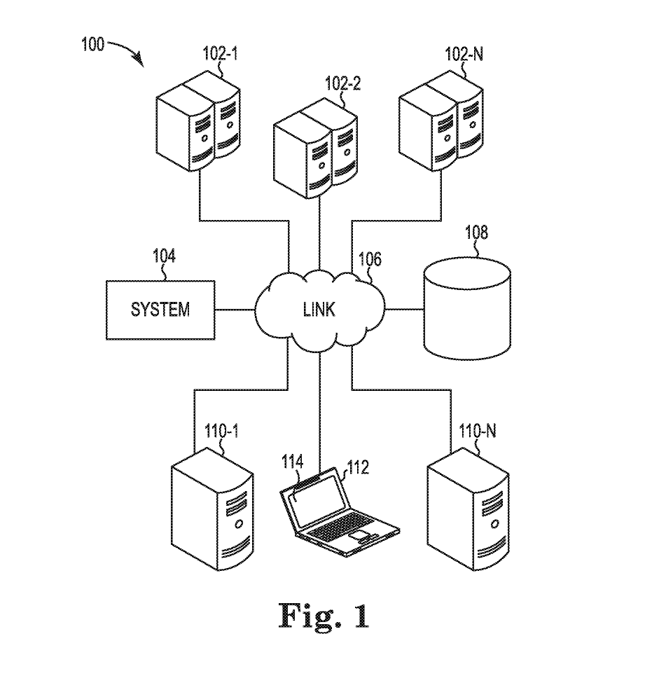

FIG. 1 illustrates a diagram of an example of an environment 100 for end user trend identification to identify information gaps according to the present disclosure. The environment 100 can include a system 104, a data store 108, server devices 102-1, 102-2, . . . , 102-N, and/or client devices 110-1,. . . , 110-N. The client devices 110-1, 110-N can include a client device 112 that includes a user interface 114.

The system 104, as described herein, can represent a number of different combinations of hardware and software configured to select a virtualization scheme for the communication between a pair of nodes based on a number of properties of the communication. The system 104 can include the computing device 304 as represented in FIG. 33.

The server devices 102-1, 102-2, . . . , 102-N can he a computing device configured to respond to network requests received from the client devices 110-1, 110-N, 112. The client devices 110-1, 110-N, 112 can include browsers and/or other applications to communicate requests with the system 104, data store 108, and/or server devices 102-1, 102-2, . . . , 102-N via a communication link 106 (e.g., network, local area network (LAN), internet, etc.).

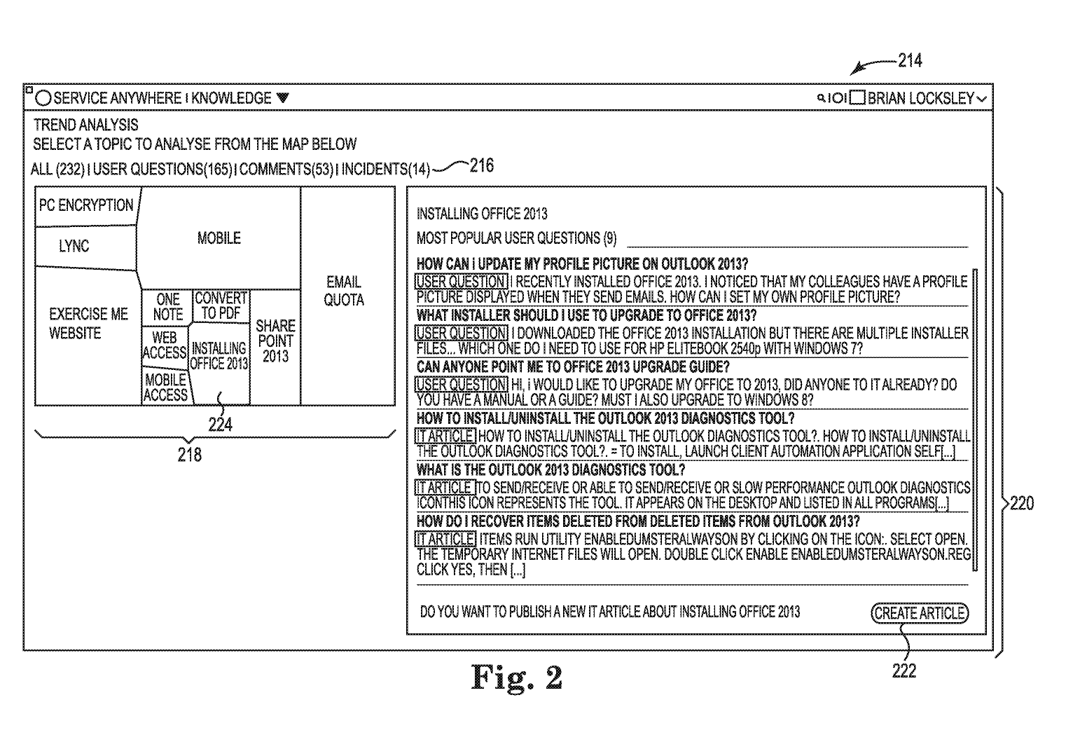

FIG. 2 illustrates a diagram of an example of a user interface 214 for end user trend identification to identify information gaps according to the present disclosure. The user interface 214 for the end user trend identification to identify information gaps can include a number of tabs 216 that can be utilized to categorize end user interactions with an information system. For example, the number of tabs 216 can include “ALL” end user interactions, “USER QUESTIONS” for end user interactions, “COMMENTS” of end user interactions, and/or “INCIDENTS” of end user interactions, among various other categories for end user interactions. An end user of the user interface 214 (e g., user interface 114 as referenced in FIG. 1, etc.) can utilize the number of tabs 216 to filter the number of end user interactions and display a particular category of the number of end user interactions.

Each of the number of tabs 216 can include a particular category of end user interactions. For example, a tab labeled “USER QUESTIONS” can include a number of user questions posted via the information system. In this example, the number of user questions can include questions posted by a number of end users when attempting to solve a technical issue.

The user interface 214 can include a topic map 218. The topic map 218 can include a number of technical issue topics relating to the information system. For example, the number of topics can include “INSTALLING OFFICE 2013” 224. Each of the number of topics within the topic map 218 can be selected to display information relating to the selected topic and end user interactions relating to the selected topic and/or the selected tab from the number of tabs 216. For example, the tab “USER QUESTIONS” can be selected from the number of tabs 216 and the topic “INSTALLING OFFICE 2013” 224 can be selected from the topic map 218. In this example, a number of results relating to end user interactions with the information system that correspond to user questions about installing Office 2013 can be displayed in the results section 220.

The results section 220 can display a number of results relating to the end user interactions based on trend data (e.g., trends of a quantity of the same and/or similar user interaction). The trend data can he generated by analyzing quantity trends of the end user interactions. For example, end user interactions for a number of questions relating to a particular topic can be tracked, and a quantity of each of the number of questions relating to the particular topic can be determined. In addition, the results section 220 can display a number of questions within a particular quantity range (e.g., questions with a greater quantity compared to other question, questions with a particular number of questions, etc.) and/or in a particular order (e.g., questions with a greatest quantity to questions with a least quantity, etc.).

Analyzing trends of the number of end user interactions can include analyzing trends of a number of determined end user technical issues (e.g., personal computer (PC) encryption problems, installing Office 2013 problems, convert to PDF problems, etc.). That is, the results section 220 can be organized based on trend analysis of the number of end user interactions and/or end user technical issues. For example, the results section 220 can include a list of end user interactions and/or end user technical issues that have a particular quantity. In this example, the particular quantity can be a quantity of end user interactions and/or determined end user technical issues that occur over a particular time period (e.g., day, week, month, etc.).

The results section 220 can be updated as trends of the end user interactions and/or end user technical issues change. For example, the results section 220 can be updated to include a current list (e.g., list from the date updated, etc.) of end user interactions and/or end user technical issues. Updating the results section 220 can be utilized to display end user interactions and/or end user technical issues that have a relatively high quantity for a particular time period. For example, the results section 220 can display end user interactions and/or end user technical issues with a greatest quantity over a particular time period, in this example, the displayed end user interactions and/or end user technical issues can be used to determine information gaps within the information system. That is, end user interactions and/or end user technical issues can correspond to information gaps of the information system.

The determined information gaps of the information system can be utilized by a system manager to determine a number of articles to create for the information system to fill the information gaps. The determined information gaps of the information system can be information gaps that end users are attempting to access more frequently than other information gaps. For example, the determined information gaps that correspond to the displayed end user interactions and/or end user technical issues can be information gaps that end users are attempting to utilize during a particular time period. The information system manager can utilize the determined information gaps to create articles and/or assign articles (e.g., IT articles, text document relating to a topic and/or category, etc.) to a number of drafters (e.g., information technology specialists, etc.) that can fill the determined information gaps.

The user interface can include a create article tab 222. The create article tab 222 can enable a drafter to view the results section 220 for a particular category and/or particular topic and select the create article tab 222 to open a different user interface for drafting an article. By enabling the drafter to view the results section 220 of the user interface 214, the drafter can review the results section 220 prior to drafting the article.

The create article tab 222 can also be utilized to create an article directed towards frequently asked questions (FAQ). For example, an FAQ article can be created with the create article tab 222. The FAQ article can include a number of questions displayed within the results section 220 with a number of corresponding answers to each of the number of questions. The article that is created utilizing the create article tab 222 can utilize responses and/or rankings of the questions corresponding to questions within the results section 220. For example, a number of end users can report a question, and the question can be displayed within the results section 220. In this example, other end users can add feedback and/or possible solutions to the question. Additionally, the number of end users can leave suggestions to the feedback and/or possible solutions. The feedback and/or possible solutions can be utilized when creating the new article in response to the question.

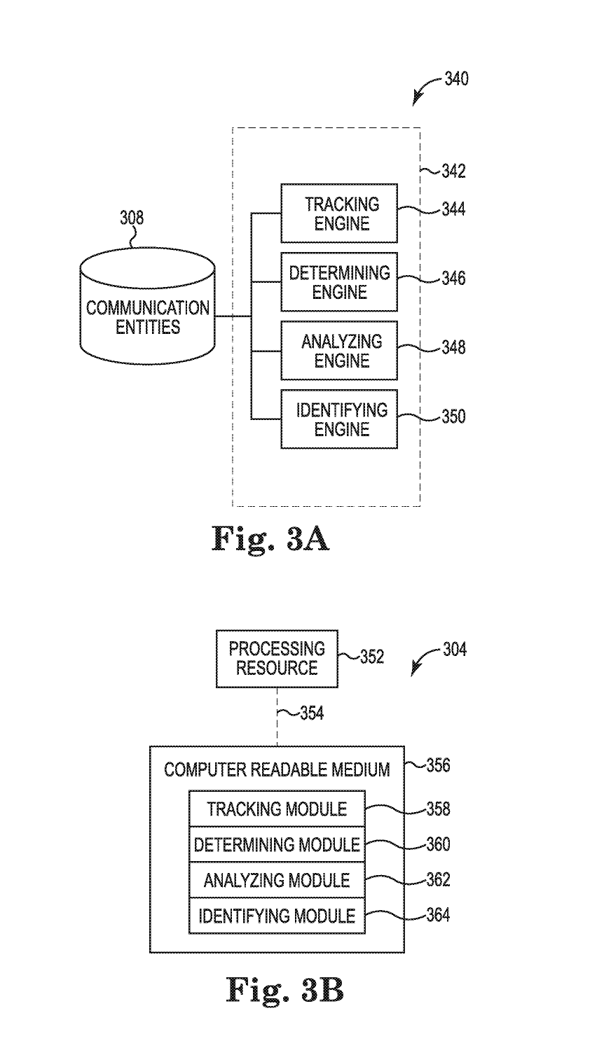

FIG. 3A illustrates a diagram of an example of a system 340 for end user trend identification to identify information gaps according to the present disclosure. The system 340 can include a data store 308 (e.g., data store 108 as referenced in FIG. 1, etc.), a system 342, and/or a number of engines 344, 346, 348, 350. The system 342 can be in communication with the data store 308 via a communication link, and can include the number of engines (e.g., tracking engine 344, determining engine 346, analyzing engine 348, identifying engine 350, etc.). The system 342 can include additional or fewer engines than illustrated to perform the various functions described herein. The system 342 can represent software and/or hardware.

The number of engines can include a combination of hardware and programming that is configured to perform a number of functions described herein (e.g., select an operable virtualization scheme from the determined number of operable virtualization schemes based on the number of properties of the communication between the pair of nodes, etc.). The programming can include program instructions (e.g., software, firmware, etc.) stored in a memory resource (e g., computer readable medium, machine readable medium, etc.) as well as hard-wired program (e.g., logic).

The tracking engine 344 can include hardware and/or a combination of hardware and programming to track end user interactions with an information system relating to a user attempting to solve a technical issue. Tracking end user interactions can include tracking the number of end users searching a number of IT articles within the information system. For example, the tracking engine can track end user search words and/or search terms when the end user is searching for IT articles within the information system. Tracking end user interactions can also include tracking the number of end users creating a number of service request tickets by the number of end users. For example, an end user can be experiencing technical difficulties (e.g., software and/or hardware of an end user device not operating as desired, software and/or hardware of an end user device not operating to specification of a manufacturer, etc.). In this example, the end user can create a service request ticket (e.g., service order, description of problem, etc.) to describe the technical difficulty to a service provider (e.g., information system manager, hardware and/or software repair specialist, etc.).

Tracking end user interactions can include tracking the number of end users creating a number of ratings for the number of service request tickets. For example, an end user can create a service request ticket and the end user can rate (e.g., give feedback, etc.) on the experience of the service request ticket. The feedback can be utilized to determine if the technical difficulties described in the service request ticket were solved. For example, an end user may give positive feedback that can correspond to the technical difficulty described in the service request ticket being solved. In another example, the end user may give negative feedback that can correspond to the technical difficulties described in the service request ticket and it can be determined that the technical difficulties were not solved.

Tracking end user interactions can also include tracking the number of end users voting on existing IT articles. For example, an end user can vote on and/or rank existing IT articles based on how helpful the IT articles were in solving the technical difficulties. It can be determined, based on the voting and/or ranking of the existing IT articles, if the IT technical difficulty still exists for the end user after reading the existing article. In addition, specific information that is lacking (e.g., specific information gaps, etc.) can be outlined within comments relating to the vote and/or rank of the existing IT articles. For example, an end user can particularly point cut in a comment section of the voting for a particular existing IT article that a solution for updating a profile picture is not defined within the particular existing IT article. In this example, it can be determined that an information gap exists relating to updating a profile picture.

The determining engine 346 can include hardware and/or a combination of hardware and programming to convert the end user interactions to text data that is representative of the end user interactions. As described herein, the end user interactions can include searching for a number of IT articles, creating a number of service request tickets, creating a number of ratings for the number of service request tickets, and/or voting on existing IT articles, among other end user interactions (e.g., video posts, audio posts, etc.). With multiple types of end user interactions, the determining engine 346 can convert the end user interactions to a particular type of text data to compare and further determine the technical issues of the end user. For example, a video post attached to a comment section of an existing IT article can be converted to text data and can be utilized similarly to text comments relating to the existing IT article. Converting the end user interactions to text data can be more efficient in determining the technical difficulties and/or technical issues of the end user as compared to analyzing the different types of end user interactions individually.

In addition, the determining engine 346 can include hardware and/or a combination of hardware and programming to determine the technical issue based on the end user interactions with the information system. As described herein, the technical issue of an end user can be determined based on the end user interactions with the information system. For example, a technical issue of deciding on a particular installer to upgrade a program can be determined based on end user interactions with the information system. In this example, the end user interactions can include individual end user interactions or a combination of various end user Interactions as described herein.

In addition, the determining engine 346 can include hardware and/or a combination of hardware and programming to determine if the technical issue still exists after the end user finishes interacting with the information system. Determining if the technical issue still exists after the end user finishes interaction with the information system can include utilizing the feedback of an existing IT article to determine if the end user was able to solve the technical issue utilizing the existing IT article. Determining if the technical issue still exists can be based on a rating and/or comments relating to an existing IT article (e.g., relatively low rating can equal a determination that the technical issue still exists after reading the IT article, relatively high rating can equal a determination that the technical issue does not exist after reading the IT article, etc.).

The analyzing engine 348 can include hardware and/or a combination of hardware and programming to analyze trends of the number of end user technical issues that still exist after the end user finishes interacting with the information system. The analyzing engine 348 can analyze trends of the number of end user technical issues and/or end user interactions with the information system to determine what end user technical issues and/or end user interactions are frequently occurring during a particular time period compared to other end user technical issues and/or end user interactions. For example, the analyzing engine 348 can analyze end user technical issues to determine a number of end user technical issues that have occurred most frequently over the past month. The trend data can be utilized by the information system manager and/or IT specialist to determine topics for creating new IT articles. That is, particular end user technical issues that are occurring more frequently can have new IT articles created to address the particular end user technical issues. This can be beneficial since it can address a technical issue that is currently affecting a greater number of end users of the information system as compared to different end user technical issues.

The analyzing engine 348 can also include hardware and/or a combination of hardware arid programming to generate a number of categories of the technical issues that are determined not to be solved by the end user. The analyzing engine 348 can generate a number of categories that are the same and/or similar to the number of categories (e.g., category tabs 216 as referenced in FIG. 2, etc.) as described herein. In addition, the analyzing engine 348 can generate a number of topics and/or sub-categories similar to the number of topics (e.g., topics within the topic map 218 as referenced in FIG. 2, etc.) as described herein. The analyzing engine 348 can determine a category and/or sub-category for each of the number of end user interactions and place each of the number of end user interactions within each category and/or sub-category.

In addition, the analyzing engine 348 can include hardware and/or a combination of hardware and programming to analyze the number of categories to determine a category with a particular quantity (e.g., greatest, least, within a particular range, etc.) of information gaps from the number of information gaps. For example, the analyzing engine 348 can determine a category that has a greater quantity of information gaps compared to other categories. By determining the category with the particular quantity of information gaps from the number of categories can enable a manager (e.g., user, database manager, database administrator, etc.) to determine categories that may need additional IT articles to address end user technical issues.

The identifying engine 350 can include hardware and/or a combination of hardware and programming to identify a number of information gaps within the information system based on the trends of the number of end user technical issues that still exist after the end user finishes interacting with the information system. Identifying the number of information gaps within the information system can include identifying topics and/or categories within the information system that may need additional IT articles to assist the number of end users in solving technical issues. In addition, the identifying engine 350 can identify particular areas within each of the number of topics and/or categories that may need additional IT articles. For example, the identifying engine 350 can identify a particular technical issue within a particular topic and/or category. In this example, the particular technical issue can be a question regarding a diagnostic tool within a topic of installing software and within a category of user questions. Identifying the particular technical issues within each category and/or topic can further define a specific technical issue to address when determining a technical issue for creating a new IT article.

FIG. 3B illustrates a diagram of an example computing device 304 according to the present disclosure. The computing device 304 can utilize software, hardware, firmware, and/or logic to perform a number of functions described herein.

The computing device 304 can be any combination of hardware and program instructions configured to share information. The hardware, for example can include a processing resource 352 and/or a memory resource 356 (e.g., computer-readable medium (CRM), machine readable medium (MRM), database, etc.) A processing resource 352, as used herein, can include any number of processors capable of executing instructions stored by a memory resource 356. Processing resource 352 may be integrated in a single device or distributed across multiple devices. The program instructions (e.g., computer-readable instructions (CRI)) can include instructions stored on the memory resource 356 and executable by the processing resource 352 to implement a desired function (e.g., identify a number of information gaps within the information system based on the trends of the number of end user technical issues arid the trends of the technical issues that are determined not be solved, etc.).

The memory resource 356 can be in communication with processing resource 352. A memory resource 356, as used herein, can include any number of memory components capable of storing instructions that can be executed by processing resource 352. Such memory resource 356 can be a nor-transitory CRM or MRM. Memory resource 356 may be integrated in a single device or distributed across multiple devices. Further, memory resource 356 may be fully or partially integrated in the same device as processing resource 352 or it may be separate but accessible to that device and processing resource 352. Thus, it is noted that the computing device 304 may be implemented on a participant device, on a server device, on a collection of server devices, and/or on a combination of the user device and the server device.

The memory resource 356 can be in communication with the processing resource 352 via a communication link (e.g., path) 354. The communication link 354 can be local or remote to a machine (e.g., a computing device) associated with the processing resource 352. Examples of a local communication link 354 can include an electronic bus internal to a machine (e.g., a computing device) where the memory resource 356 is one of volatile, non-volatile, fixed, and/or removable storage medium in communication with the processing resource 352 via the electronic bus.

A number of modules 358, 360, 362, 364 can include CRI that when executed by the processing resource 352 can perform a number of functions. The number of modules 358, 360, 362, 364 can be sub-modules of other modules. For example, the determining module 360 and the analyzing module 362 can be sub-modules and/or contained within the same computing device. In another example, the number of modules 358, 360, 362, 364 can comprise individual modules at separate and distinct locations (e.g., CRM, etc.).

Each of the number of modules 358, 360, 362, 364 can include instructions that when executed by the processing resource 352 can function as a corresponding engine as described herein. For example, the tracking module 358 can include instructions that when executed by the processing resource 352 can function as the tracking engine 344. In another example, the determining module 360 can include instructions that when executed by the processing resource 352 can function as the determining engine 346.

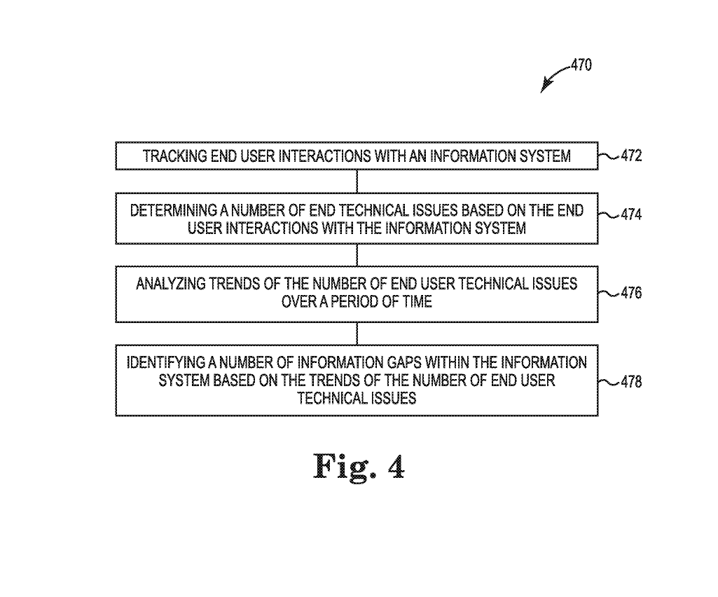

FIG. 4 illustrates a flow diagram of an example method 470 for end user trend identification to identify information gaps according to the present disclosure. As described herein, end user trend identification to identify information gas can identify information gaps to create new IT articles that relate to the identified information gaps. The method 470 for end user trend identification can identify information gaps that are currently being frequently requested by end users of the information system. The method 470 can optimize IT article generation by focusing on generating IT articles that are currently being requested by end users.

At 472, the method 470 can include tracking end user interactions with an information system. As described herein, tracking end user interactions can include tracking feedback and/or ranking of IT articles within an information system. For example, an end user can rank and/or leave feedback for a number of IT articles. In this example, the rank and/or feedback left by the end user can be recorded and converted to text.

At 474, the method 470 can include determining a number of end user technical issues based on the end user interactions with the information system. Determining the number of end user technical issues based on the end user interactions can include determining the number of end user technical issues based on the rank and/or feedback left by the end user. As described herein, the number of end user technical issues can be determined by categorizing the end user interactions into a number of categories and/or topics.

At 476, the method 470 can include analyzing trends of the number of end user technical issues over a period of time. Analyzing trends of the number of user technical issues over a period of time can include analyzing a quantity of the number of end user technical issues over the period of time. That is, analyzing trends can include determining a quantity of end user technical issues and analyzing whether the end user technical issues are increasing in quantity or decreasing in quantity. The trend data corresponding to an increase or decrease in quantity of particular end user technical issues can be utilized to identify a number of information gaps of the information system. For example, if a quantity of a particular end user technical issue is increasing and/or is greater than other end user technical issues, then it can be determined that there is a possible information gap in the information system relating to the particular end user technical issue. That is, analyzing trends of the number of end user technical issues can include comparing a first quantity of the number of end user technical issues at a first time with a second quantity of the number of end user technical issues at a second time.

At 478, the method 470 can include identifying a number of information gaps within the information system based on the trends of the number of end user technical issues. As described herein, identifying the number of information gaps within the information system can include identifying particular end user technical issues that may need additional IT articles to assist end users in fixing the end user technical issues. For example, identifying the number of information gaps can include identifying specific technical issues that end users are having difficulty solving when utilizing the information system.

As used herein, “a” or “a number of” something can refer to one or more such things. For example, “a number of end users” can refer to one or more end users. As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The figures herein follow a numbering convention in which the first digit or digits correspond to the drawing figure number and the remaining digits identify an element or component in the drawing. Similar elements or components between different figures may be identified by the use of similar digits. For example, 114 may reference element “14” in FIG. 1, and a similar element may be referenced as 214 in FIG. 2.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for end user trend identification to identify information gaps, comprising:
tracking end user interactions with an information system;
determining a number of end user technical issues based on the end user interactions with the information system;
analyzing trends of the number of end user technical issues over a period of time; and
identifying a number of information gaps within the information system based on the trends of the number of end user technical issues.

2. The method of claim 1, wherein tracking end user interactions with the information system includes tracking end user interactions that include:
searching a number of information technology (IT) articles;
creating a number of service request tickets;
creating a number of ratings for the number of service request tickets; and
voting on existing IT articles.

3. The method of claim 1, wherein determining the number of end user technical issues includes determining a number of categories and sub-categories of technical support that correspond to the end user interactions.

4. The method of claim 1, wherein identifying the number of information gaps includes identifying a number of IT articles that are not included within the information system.

5. The method of claim 4, wherein identifying the number of IT articles that are not included within the information system includes prioritizing the number of IT articles that are not included within the information system.

6. The method of claim 1, wherein analyzing trends of the number of end user technical issues includes comparing a first quantity of the number of end user technical issues at a first time with a second quantity of the number of end user technical issues at a second time.

7. A non-transitory machine-readable medium storing instructions executable by a processing resource to cause a computing device to:
track end user interactions with an information system relating to a user attempting to solve a technical issue;
determine if the technical issues based on the end user interactions with the information system;
determine which of the technical issue still exist after the end user finishes interacting with the information system;
analyze trends of the number of technical issues that still exist after the end user finishes interacting with the information system, wherein analyzing trends of the number of technical issues includes determining if the end user technical issues are altering in a quantity of technical issues over a period of time; and
identify a number of information gaps within the information system based on the trends of the number of technical issues that still exist after the end user finishes interacting with the information system.

8. The medium of claim 7, wherein the information system is a self-help information technology (IT) database that includes a plurality of IT articles relating to the number of technical issues.

9. The medium of claim 7, wherein the number of interactions include end user feedback relating to a plurality of IT articles within the information system.

10. The medium of claim 7, wherein the instructions executable to determine which of the number of technical issues still exist include instructions executable to determine if the number of interactions correspond to an end user not finding a solution to the number of technical issues that still exist.

11. The medium of claim 7, wherein the number of information gaps includes a lack of information within the information system defining how the end user can fix the number of technical issues.

12. A system for end user trend identification to identify information gaps, comprising a processing resource in communication with a non-transitory machine readable medium having instructions executed by the processing resource, comprising a tracking engine, a determining engine, an analyzing engine and an identifying engine, wherein:
the tracking engine tracks end user interactions with an information system associated with a user attempting to solve a technical issue;
the determining engine determines the technical issue based on the end user interactions with the information system and to determine whether the technical issue is solved by the end user via the end user interactions with the information system;
the analyzing engine analyzes trends of the number of technical issues and to analyze quantity trends of the technical issues determined not to be solved by the end user via the end user interactions with the information system; and
the identifying engine identifies a number of information gaps within the information system based on the trends of the number of technical issues and the trends of the technical issues that are determined not be solved.

13. The system of claim 12, including a display engine to display a visual representation of the number of information gaps within the information system.

14. The system of claim 12, wherein the analyzing engine includes instructions executable to generate a number of categories of the number of technical issues that are determined not to be solved by the end user.

15. The system of claim 14, wherein the analyzing engine includes instructions executable to analyze the number of categories to determine a category with a greatest number of information gaps from the number of information gaps.
